(19) United States
(12) Patent Application Publication
(10) Pub. No.: US 2024/0121745 A1
(43) Pub. Date: Apr. 11, 2024

(54) DATA PLANE FOR NG CELLULAR NETWORKS

(71) Applicants: Zongrui Ding, Portland, OR (US); Qian Li, Beaverton, OR (US); Alexandre Saso Stojanovski, Paris (FR); Thomas Luetzenkirchen, Taufkirchen (DE); Abhijeet Ashok Kolekar, Hillsboro, OR (US); Sudeep K. Palat, Cheltenham (GB); Youn Hyoung Heo, Sunnyvale, CA (US); Sangeetha L. Bangolae, Portland, OR (US); Xiaopeng Tong, Beijing (CN)

(72) Inventors: Zongrui Ding, Portland, OR (US); Qian Li, Beaverton, OR (US); Alexandre Saso Stojanovski, Paris (FR); Thomas Luetzenkirchen, Taufkirchen (DE); Abhijeet Ashok Kolekar, Hillsboro, OR (US); Sudeep K. Palat, Cheltenham (GB); Youn Hyoung Heo, Sunnyvale, CA (US); Sangeetha L. Bangolae, Portland, OR (US); Xiaopeng Tong, Beijing (CN)

(21) Appl. No.: 18/538,737

(22) Filed: Dec. 13, 2023

Related U.S. Application Data
(60) Provisional application No. 63/482,227, filed on Jan. 30, 2023.

(51) Int. Cl. H04W 60/04; H04W 12/06; H04W 48/18; H04W 76/20

(52) U.S. Cl. CPC H04W 60/04; H04W 12/06; H04W 48/18; H04W 76/20

(57) ABSTRACT

An apparatus, method, and system are described for data transfer between a user equipment (UE) and Data Storage Function (DSF) in a 6G system. The data transfer occurs via a control and/or user plane using a data ID and data filter defined using data ID, metadata, data source, and labeling. User plane data transfer is based on a protocol data unit (PDU) or a standalone data session. The DSF provides data services by service application programming interfaces (APIs). A Service Infrastructure Control Function (SICF) configures routing policies to an evolved Service Communication Proxy User Plane (eSCP-U) to route data inquiries to the correct DSF using a service mesh.

### PRIORITY CLAIM

This application claims the benefit of priority to U.S. Provisional Patent Application Ser. No. 63/482,227, filed Jan. 30, 2023, which is incorporated herein by reference in its entirety.

### BACKGROUND

Mobile communication has evolved significantly from early voice systems to highly sophisticated integrated communication platform. Next-generation (NG) wireless communication systems, including 5^{th} generation (5G) and sixth generation (6G) (also referred to as new radio (NR) or next generation (NG)) systems, are to provide access to information and sharing of data by various users (e.g., user equipment (UEs)) and applications. A NR system is to be a unified network/system that is to meet vastly different and sometimes conflicting performance dimensions and services driven by different services and applications. As such the complexity of such communication systems has increased. As expected, a number of issues abound with the advent of any new technology, including complexities related to data plane management in NR systems.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some aspects.

FIG. 3 illustrates a 6G reference architecture in accordance with some embodiments.

FIG. 4 illustrates data plane control functions and user functions in accordance with some embodiments.

FIG. 5 illustrates a data registration procedure in accordance with some embodiments.

FIG. 6 illustrates a data collection procedure in accordance with some embodiments.

FIG. 7 illustrates data session establishment between a UE and data storage function (DSF) in accordance with some embodiments.

FIG. 8 illustrates a data session establishment using a protocol data unit (PDU) session in accordance with some embodiments.

FIG. 9 illustrates evolved Service Communication Proxy (SCP) User Plane (eSCP-U) configurations for data service routing in accordance with some embodiments.

FIG. 10 illustrates a method of data transmission in accordance with some aspects.

FIG. 11 illustrates a method of data identifier (ID) generation in accordance with some aspects.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

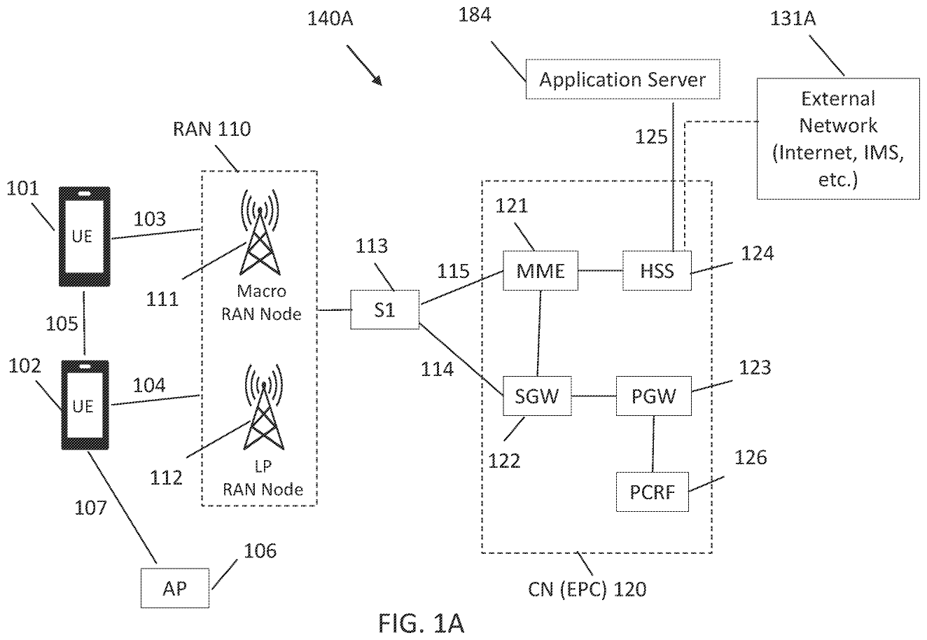

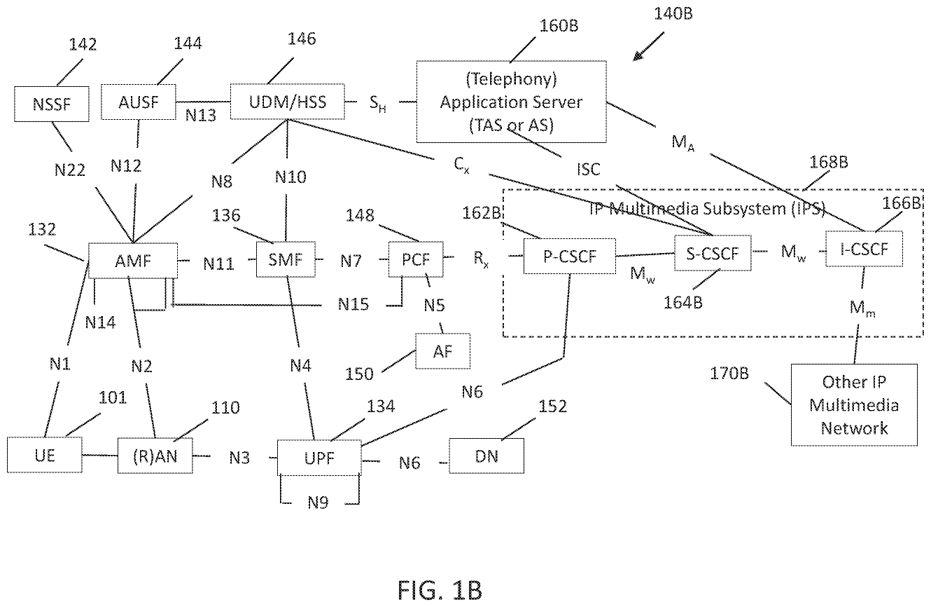

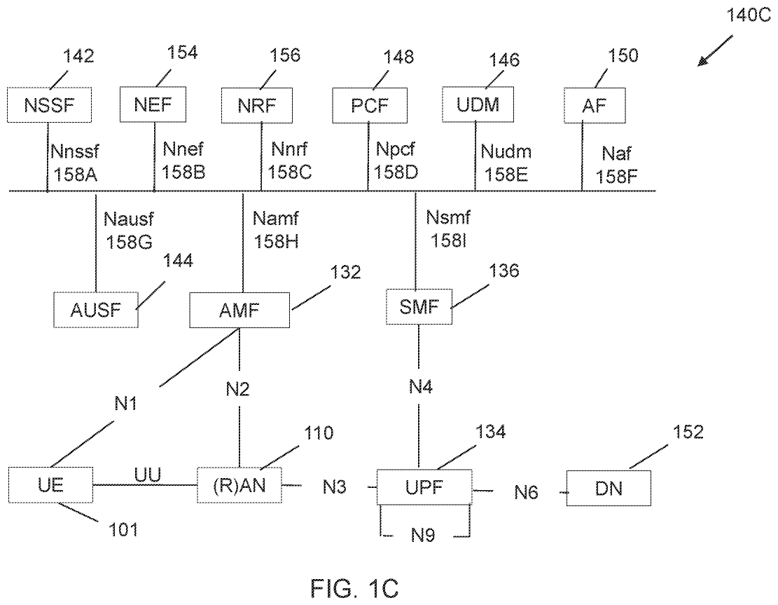

FIG. 1A illustrates an architecture of a network in accordance with some aspects. The network 140A includes 3GPP Long Term Evolution (LTE), 4^{th} generation (4G) and 5^{th} generation (5G) (or next generation (NG)) network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below), in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a UMTS protocol, a 3GPP LTE protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), 5^{th} Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs, gNBs or xNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain. LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs (or xNBs). The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a primary node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134). N4 (between the SMF 136 and the UPF 134), N5 (between the PCF 148 and the AF 150, not shown), N6 (between the UPF 134 and the DN 152), N7 (between the SMF 136 and the PCF 148, not shown). N8 (between the UDM 146 and the AMF 132, not shown), N9 (between two UPFs 134, not shown), N10 (between the UDM 146 and the SMF 136, not shown), N1 (between the AMF 132 and the SMF 136, not shown). N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown). N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

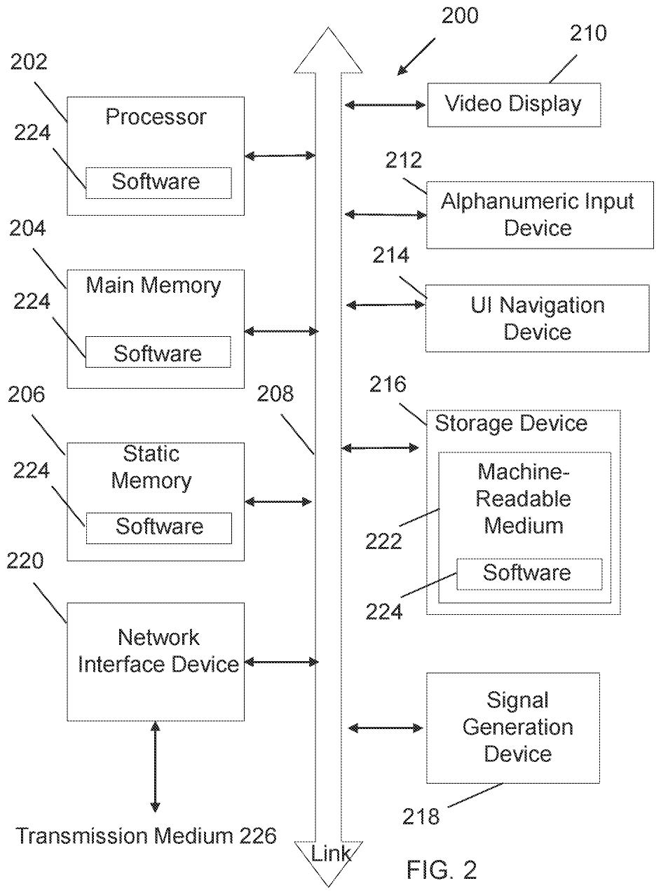

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. A storage device 216 that includes the non-transitory machine readable medium should not be construed as that either the device or the machine-readable medium is itself incapable of having physical movement. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices: magnetic disks, such as internal hard disks and removable disks; magneto-optical disks; Random Access Memory (RAM): and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as IEEE 802.11 family of standards known as Wi-Fi, IEEE 802.16 family of standards known as WiMax, IEEE 802.15.4 family of standards, an LTE family of standards, a UMTS family of standards, peer-to-peer (P2P) networks, a 5G standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to; a GSM radio communication technology, a GPRS radio communication technology, an Enhanced Data Rates for GSM Evolution (EDGE) radio communication technology, and/or a Third Generation Partnership Project (3GPP) radio communication technology, for example UMTS, Freedom of Multimedia Access (FOMA), 3GPP LTE, 3GPP Long Term Evolution Advanced (LTE Advanced), Code division multiple access 2000 (CDMA2000), Cellular Digital Packet Data (CDPD), Mobitex, Third Generation (3G). Circuit Switched Data (CSD). High-Speed Circuit-Switched Data (HSCSD), UMTS (3G), Wideband Code Division Multiple Access (UMTS) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), UMTS-Time-Division Duplex (UMTS-TDD), TD-CDMA. Time Division-Synchronous Code Division Multiple Access, 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), E-UTRA, LTE Advanced (4G), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), PTT, Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.1 lad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, Dedicated Short Range Communications (DSRC) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5.855 GHz to 5,875 GHz), ITS-G5C (i.e., Operation of ITS applications in the frequency range 5,470 GHz to 5.725 GHz)), DSRC in Japan in the 700 MHz band (including 715 MHz to 725 MHz), IEEE 802.11 bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include International Mobile Telecommunications spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 70) MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as Program Making and Special Events (PMSE), medical, health, surgery, automotive, low-latency, drones, etc. applications.

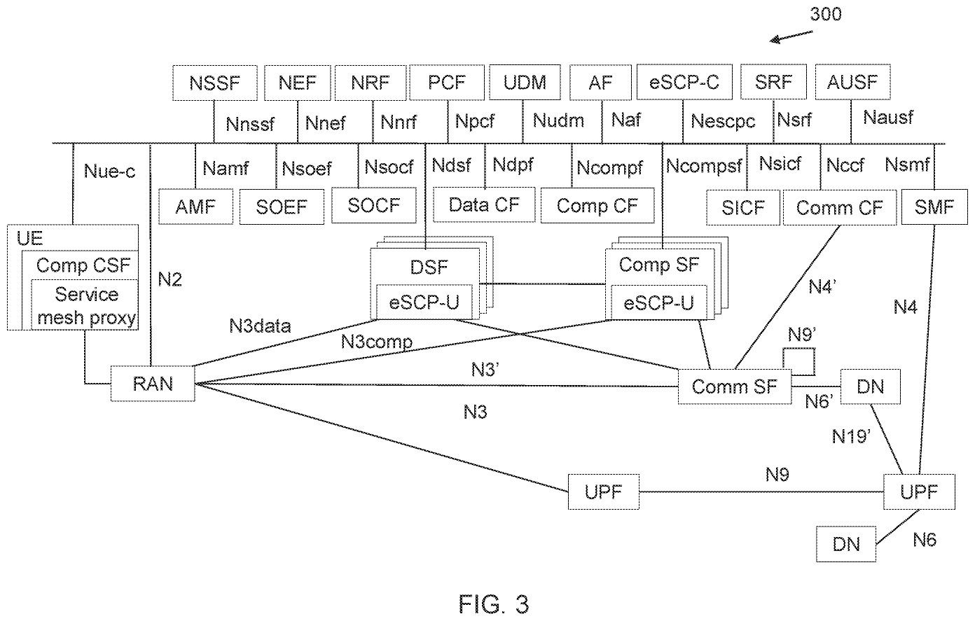

As above, extending the 5G architecture, the 6G System (6GS) is expected to incorporate computing and data services/applications. In addition to the architectures shown in described above, the 6GS includes both evolved functions and new functions. FIG. 3 illustrates a 6G reference architecture 300 in accordance with some embodiments. The evolved functions shown in FIG. 3 include the RAN, AMF, SMF, and UPF. The new functions shown in FIG. 3 include a Service Orchestration and Chaining Function (SOCF), a Service Infrastructure Control Function (SICF), an evolved Service Communication Proxy (SCP) Control Plane (eSCP-C), an evolved SCP User Plane (eSCP-U), a Computing Client Service Function (Comp CSF) at the UE side, a Service Orchestration and Chaining Exposure Function (SOEF), a Computing Control Function (Comp CF), a Computing Service Function (Comp SF), a Communication Control (Comm CF), a Communication Service Function (Comm SF), a Data Service Function (DSF), Data Control Plane Function (Data CF), and a Service Registration Function (SRF). In the 6GS, the Comp CF, Comp SF, Data CF, Data SF, SOCF, SRF provides functionalities and interfaces for computing and data service discovery, selection, creation, access, (re)-configuration, monitoring, migration, and release.

The SOCF is used to discover, orchestrate, and chain up communication/computing/data services provided by functions in the network. Upon receiving service requests from users, the SOCF interacts with the Comp CF/Comm CF/Data CF to identify Comp SF/Comm SF/Data SF instances, configure service resources, and generate the service chain, which could contain multiple Comp SF, Comm SF and Data SF instances and their associated computing endpoints. Workload processing and data movement may then be conducted within a generated service chain. The SOCF is also responsible for maintaining, updating and releasing a service chain.

The eSCP and SICF provide service communication infrastructure for control plane services and user plane services. The eSCP includes user plane service communication proxy capabilities in addition to the 5G SCP capabilities. The eSCP is split into the eCSP-C, the control plane service communication proxy, and the eSCP-U, the user plane service communication proxy. The SICF controls and configures eCSP instances in terms of service traffic routing policies, access rules, load balancing configurations, and performance monitoring.

The computing service plane includes the Comp CF and Comp SF. The Comp CF is a control plane function that provides Comp SF management, computing task context generation and management (e.g., create, read, modify, delete), and interaction with the underlying computing infrastructure for computing resource management. The Comp SF is a user plane function that serves as the gateway to interface computing service users (such as UEs) and computing nodes behind a comp SF instance. The Comp SF functionalities include parsing of computing service data received from users to compute tasks executable by computing nodes, retaining service mesh ingress gateways or service application programming interface (API) gateways, service and charging policy enforcement, performance monitoring, and telemetry collection. A Comp CF instance is able to control multiple Comp SF instances, each of which is able to serve as a user plane gateway for a cluster of computing nodes. A service mesh handles low-level communications such as service discovery, service-to-service authentication, and traffic encryption. An API gateway handles higher-level communications, such as request routing, authentication, and response transformation for external clients.

The communication service plane similarly includes the Comm CF and Comm SF, similar to the SMF and UPF. The Comm CF is a control plane function that manages the Comm SF, communication sessions creation/configuration/release, and communication session context. The Comm SF is a user plane function that is used for data transport.

The SOEF is configured to expose service orchestration and chaining services to external users such as applications.

The data service plane includes the Data CF and Data SF. The Data CF is a control plane function that provides functionalities such as Data SF management, data service creation/configuration/releasing, and data service context management. The Data SF is a user plane function and serves as the gateway between data service user (such as UEs and network functions) and data service endpoints behind the gateway. The Data SF functionalities include parsing data service user data and forwarding the data to corresponding data service endpoints, generating charging data, and reporting data service status.

The SRF is a registry for system services provided in the user plane, such as services provided by service endpoints behind the Comp SF and Data SF gateways, and services provided by UE computing.

The UE may include a computing client service function (comp CSF). The comp CSF has both control plane functionalities and user plane functionalities and interacts with corresponding network side functions such as the SOCF, Comp CF/Comp SF and Data CF/Data SF for service discovery, request/response, compute task workload exchange, etc., as well as with network side functions to decide whether a computing task should run on UE computing or network computing. The UE and/or the Comp CSF may include a service mesh proxy. The service mesh proxy may act as a proxy for service-to-service communication in the user plane. Capabilities of the service mesh proxy may include one or more of addressing, security, load balancing, etc.

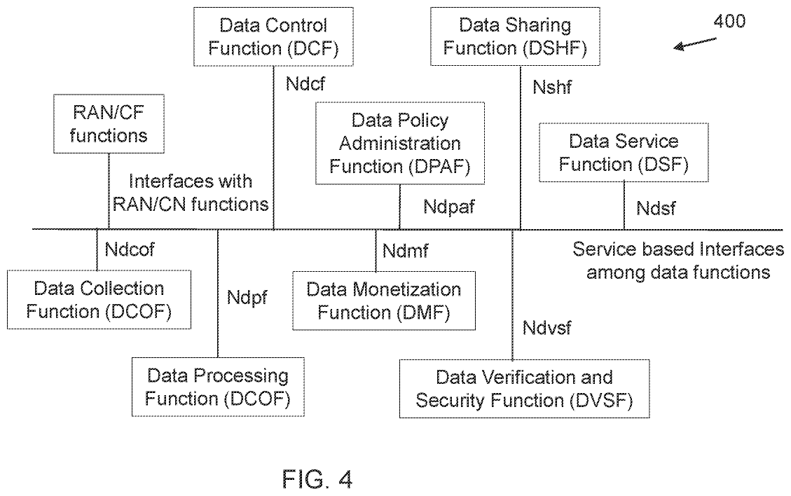

The 6G data plane architecture may include control functions and user plane functions for data plane. FIG. 4 illustrates data plane control functions and user functions in accordance with some embodiments. The architecture 400 includes control plane functions for Data Plane include a Data Collection Function (DCOF), a Data Control Function (DCF), a Data Verification and Security Function (DVSF), a Data Processing Function (DPF), a Data Storage Function (DSF), a Data Sharing Function (DSHF), a Data Monetization Function (DMF), and a Data Policy Administration Function (DPAF). The user plane function for the data plane is a Data Service Function (DSF).

The DSF provides a gateway for data consumers and producers to access data storage. The Data CF includes the DCF, the DPAF, the DVSF, the DSHF, and the DCOF. The Data CF functionality control the DSF and manage data collection, sharing, access, and DSF (re)configuration. The DSF has both a control plane interface and a user plane interface, allowing the DSF to serve data produced/consumed by both control plane functions and user plane functions.

The UE may interact with the data plane functions for control or user traffic, which are evolved from the current 5G Network Data Analytics Function (NWDAF)/Data Collection Coordination Function (DCCF) framework. As described herein, the data ID and related context information to be used in data transfer between the UE and cellular network are defined, in additional to the analytics ID defined in NWDAF/DCCF framework. In addition, a mechanism is described herein for the transfer of data using the control plane or set up data sessions using the user plane to transfer data between the UE and a DSF. A mechanism to provide data services using the DSF and reflect configurations to the eSCP-U for a service mesh in the 6GS are also described herein.

The mechanisms for the UE to transfer data to the DSF via the control plane or user plane use the data ID and data filter defined using the data ID, metadata, data source, and labeling. For user plane options, the data transfer may be based on a PDU session or a standalone data session. The DSF may also provide data services by service APIs, which may be third party APIs. The SICF may also configure routing policies to the eSCP-U to route data inquiries to the right DSF using the service mesh. Note that policies are usually used to mean a set of rules and parameters, whereas instructions may be wider than policies and may include data policies and other information (such as routing information).

5.1.1 Data ID and Data Registry

Data ID: To identify a piece of data in the 6GS, a data ID is shared between UEs and the network to uniquely point to the data. A data ID may be in the form of a string or a Uniform Resource Identifier (URI). One piece of data may be allocated multiple data IDs and stored with multiple copies. Data ID may also be hierarchical to include domain name, data source, time stamp, etc. With the same data ID, data may be updated, and the metadata and labels may be regenerated by operations such as verification.

A data registry maintains information about the data in the 6GS. This information includes but not limited to the data ID, metadata such as data source, data description, data precision, data size, data collection rules, etc., data labels such as time stamps and keywords, and security related keys. The data registry may be maintained by the DCF, DCOF, DSHF and/or as a standalone function in the 6GS. The data registry may respond to requests for data queries based on the data ID, as well as allocating a data ID to a specific piece of data. The DSF updates the data registry if any changes are made to the data.

5.1.1.1 Data ID Allocation During Data Registration

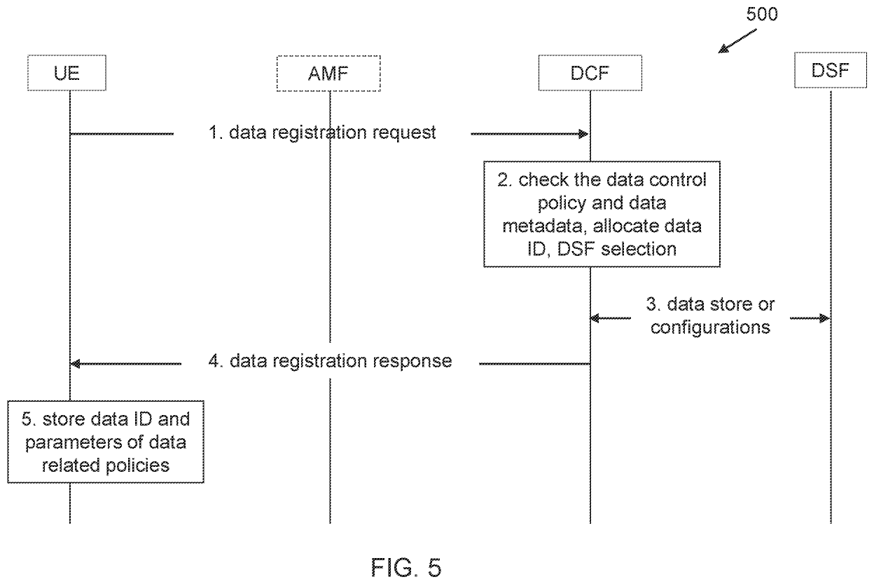

FIG. 5 illustrates a data registration procedure in accordance with some embodiments. During the procedure 500, the UE may request to register data to the data registry. In this example, the data registry is maintained as part of the DCF functionality as shown in FIG. 5. Data may be sent from the UE to the selected DSF via the control plane or via a separate procedure on the user plane.

At operation 1, the UE sends a data registration request to the DCF via a non-access stratum (NAS) container (through the AMF), a distributed NAS, an HTTP using a service-based interface (SBI) N2 interface or radio resource control (RRC) message via a Central Unit for Control Plane (CU-CP). This request includes the metadata for data registration and security keys for authentication. The request may include the data for registration directly.

At operation 2, the DCF checks the UE's context and metadata, which may involve an additional verification process with the AMF, the Security Anchor Function (SEAF) or the DVSF. The DCF allocates the data ID and selects a DSF if the UE is allowed to further send the data to the DSF. This data ID may be encrypted using the UE's security keys. The DSF selection may be based on data type, location, security requirements, single Network Slice Selection Assistance Information (S-NSSAI), etc.

After selection of a DSF, at operation 3, the DCF may further configure the DSF with the data ID, UE context, data labels, metadata, and the policy of storing the data. For example, additional DSFs may be involved to hold replicas of the data. This process may involve the DPAF. If the data is sent in operation 1, the DCF may send the data directly to the DSF. The DSF may combine data received in multiple registration messages to send the DSF.

At operation 4, the DCF sends a data registration response to the UE to indicate whether the data registration is accepted or rejected. This message includes the allocated data ID and additional instructions on data transfer.

At operation 5, the UE stores the data ID, the selected DSF identifier and other data policies such as parameters for data transfer if the data is not sent in operation 1.

5.1.1.2 Data ID Allocation During Data Collection

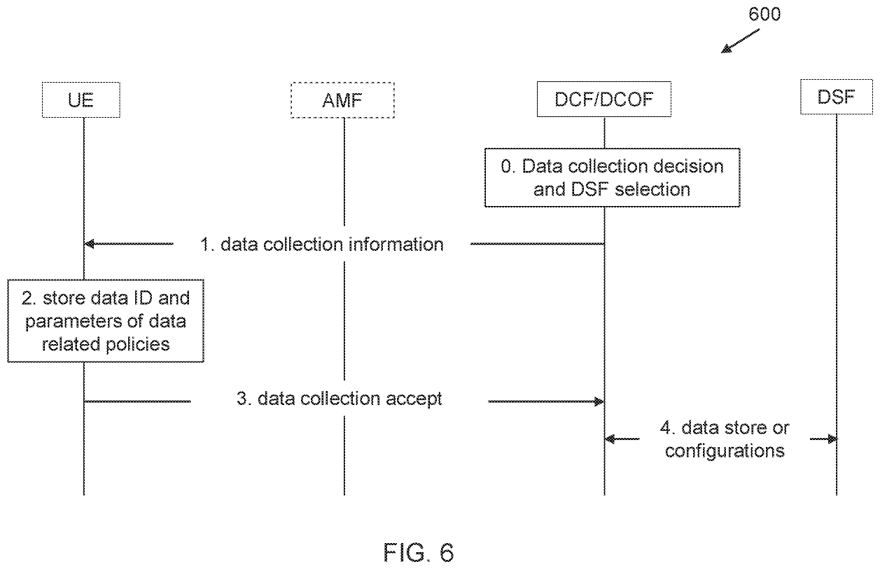

FIG. 6 illustrates a data collection procedure in accordance with some embodiments. The 6G network can also allocate a data ID and send to UE during data collection as shown in the process 600 of FIG. 6.

At operation 0, the DCF receives a data collection decision, e.g., from a DCOF and selects a DSF if data transfer is expected for this data collection.

At operation 1, the DCF sends a data collection information message to the UE. The message includes the data metadata, data collection policy, data ID, selected DSF identifier, etc. This message may be sent using one or more NAS containers, distributed NAS messages, or a HTTP message through a SBI N2 interface or RRC message via a CU-CP.

At operation 2, the UE stores the data ID, the data collection policy (such as the collection frequency), data metadata, and other data policies such as parameters for data transfer policies.

At operation 3, the UE sends a data collection accept message to accept or reject the data collection information message. The UE may piggyback the data to the DCF using the control plane.

At operation 4, the DCF selects a DSF in a manner similar to operation 3 of FIG. 5 to configure the DSF for future data transfer.

5.1.2 Data Transfer Between UE and Network

5 1.2.1 Data Session Establishment Using Direct Interface N3 Data Between an xNB and a DSF.

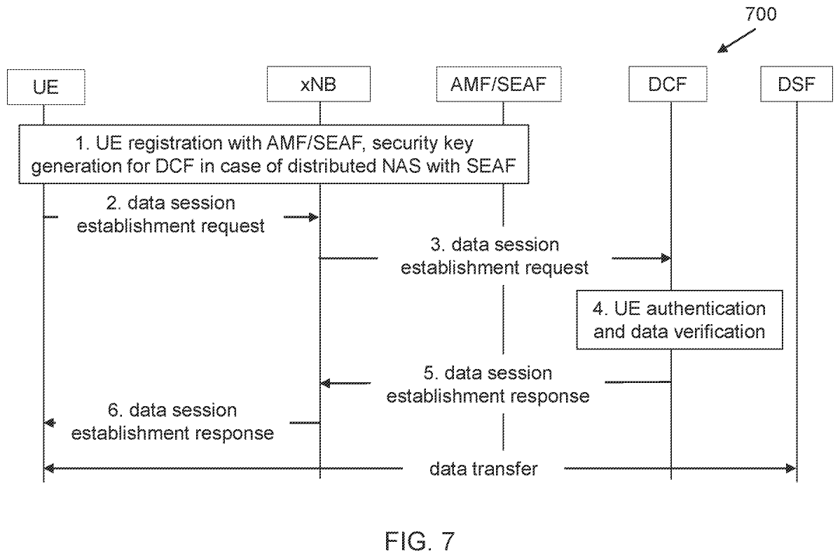

FIG. 7 illustrates data session establishment between a UE and DSF in accordance with some embodiments. A data session can be established to transfer data between a UE and a DSF as shown in the process 700 with a direct interface N3 data (in FIG. 3). This data session may be independent with PDU sessions and may not involve SOCF/CommCF/SMF. A DSF identifier is sent by a separate procedure in 5.1.1.

At operation 1, the UE performs registration with the AMF/SEAF and generates security keys such as Kseaf and Kdcf.

At operation 2, the UE sends a data session establishment request to the xNB including the data ID, data labeling and DSF identifier, security keys for the data if any is allocated to the data ID. This message may be in RRC or NAS containers or a distributed NAS or HTTP message using the SBI between the UE and NFs.

At operation 3, the xNB sends the data session establishment request message to the DCF for authentication between the UE and the DCF as well as verification of the data ID, metadata and additional keys.

At operation 4, the DCF may retrieve the UE/DCF key from the SEAF to verify the UE and the data ID, metadata, assigned DSF, routing information and additional keys for this piece of data.

At operation 5, the DCF sends a data session establishment response message to the xNB. The xNB stores the data ID, DSF ID and routing information for the data session.

At operation 6, the xNB sends the data session establishment response to the UE to indicate whether the data session is established successfully. The UE may also be provided with a temporary data session ID.

The data session may be enabled with different quality of services (QoSs) based on the urgency of the data transfer. The mechanisms are similar to computing sessions and use related changes on the SDAP. For traffic that arrives at the xNB (e.g., the CU-CP), the data ID or temporary data session ID may be used to look up the related routing information stored at the xNB. Note that the xNB may decide based on configurations whether or not the data session establishment procedure involves a PDU session.

5.1.2.2 Data Session Establishment Using a PDU Session.

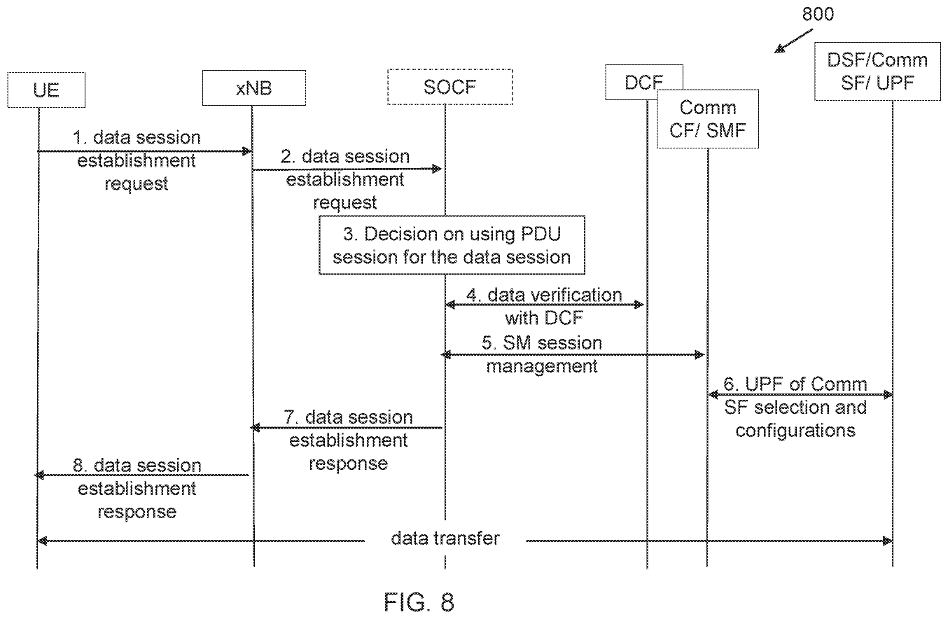

FIG. 8 illustrates a data session establishment using a PDU session in accordance with some embodiments. A data session may also be enabled if the data transfer path involves a UPF or Comm SF. In this case, the data session establishment involves a SMF/Comm CF as shown in the procedure 800 of FIG. 8.

At operation 1, the UE sends the data session establishment request to the xNB. The xNB forwards the data session establishment request to the SOCF at operation 2.

At operation 3, the SOCF decides to use a PDU session for a data session based on the information received in the data session establishment request. The data session establishment request includes a data ID, data metadata, DSF identifier, etc.

At operation 4, the SOCF verifies data information with the DCF.

At operation 5, the SOCF sends a request to the Comm CF or the SMF for SM session management. SM session management includes creation of the session context and the related QoS, UE context, etc.

At operation 6, the Comm CF/SMF performs CommSF or UPF selection to configure the Comm SF or UPF with the session context.

At operation 7, the SOCF sends a data session response to the xNB: at operation 8, the xNB forwards the data session response to the UE. The SDAP may be configured using the PDU session ID and QoS.

5.1.3 Data Services in the DSF

The data functions on the control plane may not be all available to interact with the UE on control plane. The DSF may provide additional data services using standardized APIs on the user plane to interact with applications. This service may be used for the UE or AF through the NEF. The DSF may also integrate and expose third party data service APIs such as an AWS data API or Google data API.

TABLE 1
Data services provided by DSF APIs

| | | Purpose |
|---|---|---|
| Data service | | or output |
| examples | Input parameters | parameters |
| Data processing | Data ID, data, metadata, | Data processing |
| | processing name, processing | results |
| | applications and requirements | |
| Data registration | Data, metadata, data source, | Data ID, data |
| | data labels, etc. | retention policy |
| Data trigger | Data ID, triggering conditions, | actions when |
| | data, metadata | triggered |
| Data sharing | Data and metadata, sharing | Data sharing with |
| | conditions | other applications |
| Application | Data and metadata, data | Data management |
| required | update period, data | automation |
| actions | modification policy, | |
| | data disposal policy | |

5.1.4 eSCP-C and eSCP-U Configurations for Routing Data Service Messages

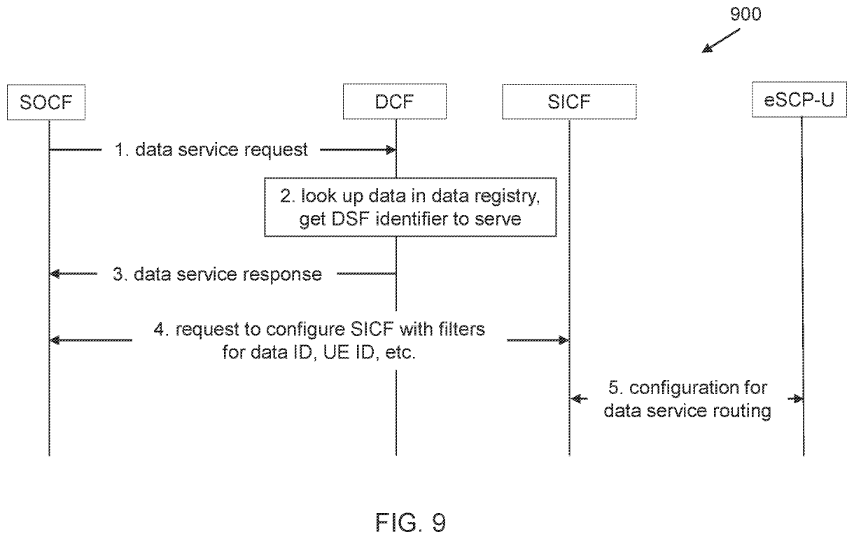

FIG. 9 illustrates eSCP-U configurations for data service routing in accordance with some embodiments. Data related policies may also be configured in the eSCP-C to route data queries to different data functions on the control plane and/or the eSCP-U to different DSFs or data storage as shown in the procedure 900 of FIG. 9. The DCF may request the SICF to configure the eSCP-U for routing data queries to the correct DSF or third party data service APIs.

At operation 1, the SOCF generates data service requirements and sends a data service request to the DCF. This request includes the data filter such as data ID, data service, or the metadata.

At operation 2, the DCF looks up the data or data service in a data registry using the data filter or the service registry using the SRF. A DSF is selected for the data service or data storage.

At operation 3, the DSF identifier is sent to the SOCF in a data service response.

At operation 4, the SOCF sends a request to the SICF to configure the routing rule of the data or data service in the eSCP-U.

At operation 5, the SICF configures the eSCP-U based on the information in operation 4. The information may include the UE ID, session ID, data ID, metadata of the data, or data service.

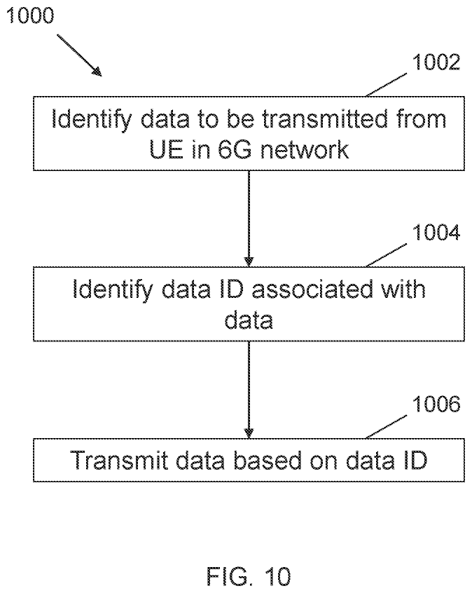

In some embodiments, the electronic device(s), network(s), system(s), chip(s) or component(s), or portions or implementations thereof of the above figures may be configured to perform one or more processes, techniques, or methods as described herein, or portions thereof. One such process is depicted in FIG. 10, which illustrates a method of data transmission in accordance with some aspects. The process 1000 of FIG. 10 may include or relate to a method to be performed by a UE, one or more elements of a UE, and/or an electronic device that includes or implements a UE. The process 1000 may include identifying, at operation 1002, data that is to be transmitted from the UE in a 6G cellular network; identifying, at operation 1004, a data identifier (ID) associated with the data; and transmitting, at operation 1006, the data based on the data ID.

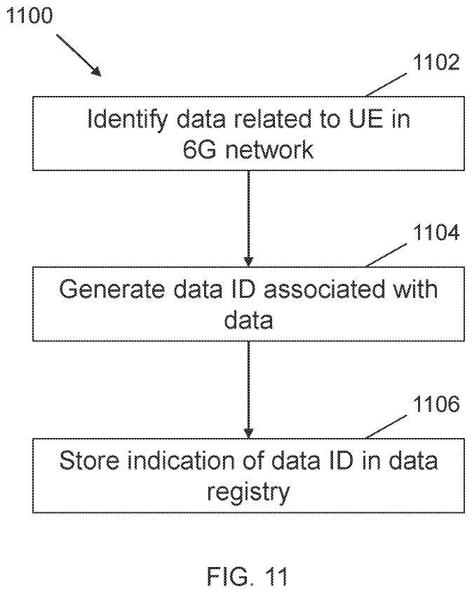

Another such process is depicted in FIG. 11, which illustrates a method of data ID generation in accordance with some aspects. The process 1100 of FIG. 11 may include or relate to a method to be performed by a network entity, one or more elements of a network entity, and/or an electronic device that includes and/or implements the network entity. The process may include identifying, at operation 1102, data related to a UE in a 6G cellular network; generating, at operation 1104, a data ID associated with the data; and storing, at operation 1106, an indication of the data ID in a data registry.

### EXAMPLES

Example 1 is an apparatus configured to operate as a Data Control Function (DCF) in a 6th generation system (6GS), the apparatus comprising: processing circuitry to configure the DCF in the 6GS to: receive a data registration request from a user equipment (UE): allocate a data identifier (ID) in response to reception of the data registration request, and send a data registration response to the UE to indicate whether the data registration request is accepted, the data registration response including the data ID; and a memory configured to store the data ID.

In Example 2, the subject matter of Example 1 includes, wherein: the processing circuitry further configures the DCF to receive the data registration request via a non-access stratum (NAS) container, a distributed NAS, a Hypertext Transfer Protocol (HTTP) using a service-based interface (SBI) N2 interface or radio resource control (RRC) message via a Central Unit for Control Plane (CU-CP), and the data registration request includes metadata for data registration and security keys for authentication.

In Example 3, the subject matter of Examples 1-2 includes, wherein the processing circuitry further configures the DCF to check UE context and metadata through verification with an Access and Mobility Function (AMF), a Security Anchor Function (SEAF), or a Data Verification and Security Function (DVSF).

In Example 4, the subject matter of Examples 1-3 includes, wherein the processing circuitry further configures the DCF to select a Data Storage Function (DSF) in response to a determination that the UE is allowed to send data to the DSF.

In Example 5, the subject matter of Example 4 includes, wherein the processing circuitry further configures the DCF to select the DSF based on at least one of data type, location, security requirements, or single Network Slice Selection Assistance Information (S-NSSAI).

In Example 6, the subject matter of Examples 4-5 includes, wherein the processing circuitry further configures the DCF to configure the DSF with the data ID, UE context, data labels, metadata, and policy of storing data from the UE.

In Example 7, the subject matter of Example 6 includes, wherein the processing circuitry further configures the DCF to: receive data from the UE in the data registration request: and send the data from the data registration request to the DSF during configuration of the DSF.

In Example 8, the subject matter of Example 7 includes, wherein the processing circuitry further configures the DCF to send a set of data from multiple data registration requests to the DSF.

In Example 9, the subject matter of Examples 1-8 includes, wherein the processing circuitry further configures the DCF to: send a data collection information message to the UE: and receive, in response to reception of the data collection information message by the UE, a data collection accept message from the UE that indicates whether the data collection information message is accepted by the UE.

In Example 10, the subject matter of Example 9 includes, wherein: the data collection information message includes data metadata, a data collection policy, the data ID, and a selected Data Storage Function (DSF) identifier, and the data collection policy and parameters for data transfer are stored in the UE, and the data collection policy includes collection frequency.

In Example 11, the subject matter of Examples 9-10 includes, wherein the processing circuitry further configures the DCF to: select a Data Storage Function (DSF) in response to a determination that the UE is allowed to send data to the DSF; and configure the DSF with the data ID. UE context, data labels, metadata, and policy of storing data from the UE.

In Example 12, the subject matter of Examples 1-11 includes, wherein the processing circuitry further configures the DCF to: receive, from a next generation NodeB (xNB), a data session establishment request from the UE to establish a data session, the data session establishment request including the data ID, data labels and Data Storage Function (DSF) identifiers, and security keys for data; and in response to reception of the data session establishment request, send a data session establishment response to the UE via the xNB, the data session establishment response indicating whether the data session is established successfully.

In Example 13, the subject matter of Example 12 includes, wherein the processing circuitry further configures the DCF to in response to reception of the data session establishment request: retrieve a UE/DCF key from a Security Anchor Function (SEAF): and use the UE/DCF key to verify the UE, the data ID, metadata, an assigned DSF, routing information, and additional keys for the data prior to sending the data session establishment response.

In Example 14, the subject matter of Examples 1-13 includes, wherein the processing circuitry further configures the DCF to: receive, from a Service Orchestration and Chaining Function (SOCF), a data verification request, the data verification request based on a data session establishment request sent to the SOCF from the UE via a next generation NodeB (xNB) to establish a data session, the data session establishment request including the data ID, data labeling and Data Storage Function (DSF) identifiers, and security keys for data; and in response to reception of the data verification request, verify data information for the SOCF to send a data session establishment response to the UE via the xNB, the data session establishment response indicating whether the data session is established successfully.

In Example 15, the subject matter of Examples 1-14 includes, wherein the processing circuitry further configures the DCF to: receive, from a Service Orchestration and Chaining Function (SOCF), a data service request that includes a data filter, the data filter containing at least one of the data ID, data service, or metadata; and in response to reception of the data service request, look up at least one of data in a data registry using the data filter or the data service in a service registry using a Service Registration Function (SRF).

In Example 16, the subject matter of Example 15 includes, wherein the processing circuitry further configures the DCF to: select a Data Storage Function (DSF) for the data service or data storage; and send a data service response to the SOCF, the data service response including a DSF identifier of the DSF.

Example 17 is an apparatus configured to operate as a user equipment (UE), the apparatus comprising: processing circuitry to configure UE to: send a data registration request to a Data Control Function (DCF) in a 6th generation system (6GS); receive, in response to reception of the data registration request by the DCF, a data registration response from the DCF to indicate whether the data registration request is accepted; receive a data collection information message from the DCF; and send, in response to reception of the data collection information message, a data collection accept message to the DCF that indicates whether the data collection information message is accepted, at least one of the data registration response or the data collection information message including a data identifier (ID) allocated by the DCF to identify data for transfer between the UE and a Data Storage Function (DSF) in the 6GS; and a memory configured to store the data ID.

In Example 18, the subject matter of Example 17 includes, wherein the processing circuitry further configures the UE to: transfer data with the DSF using at least one of a control plane or a user plane; to transfer the data using the control plane, send the data directly to the DCF to forward to the DSF; and to transfer the data using the user plane, establish at least one of: a data session that is independent of a protocol data unit (PDU) session between the UE and the DSF, or a PDU session managed by a Communication Control (Comm CF) or session management function (SMF).

Example 19 is a non-transitory computer-readable storage medium that stores instructions for execution by one or more processors of a Data Control Function (DCF) in a 6th generation system (6GS), the one or more processors to configure the DCF to, when the instructions are executed: receive a data registration request from a user equipment (UE); allocate a data identifier (ID) in response to reception of the data registration request; and send a data registration response to the UE to indicate whether the data registration request is accepted, the data registration response including the data ID.

In Example 20, the subject matter of Example 19 includes, wherein the one or more processors further configure the DCF to: select a Data Storage Function (DSF) in response to a determination that the UE is allowed to send data to the DSF: configure the DSF with the data ID, UE context, data labels, metadata, and policy of storing data from the UE; after configuration of the DSF, send a data collection information message to the UE: and receive, in response to reception of the data collection information message by the UE, a data collection accept message from the UE that indicates whether the data collection information message is accepted by the UE.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus configured to operate as a Data Control Function (DCF) in a 6^{th} generation system (6GS), the apparatus comprising:
processing circuitry to configure the DCF in the 6GS to:
receive a data registration request from a user equipment (UE):
allocate a data identifier (ID) in response to reception of the data registration request; and
send a data registration response to the UE to indicate whether the data registration request is accepted, the data registration response including the data ID; and
a memory configured to store the data ID.

2. The apparatus of claim 1, wherein:
the processing circuitry further configures the DCF to receive the data registration request via a non-access stratum (NAS) container, a distributed NAS, a Hypertext Transfer Protocol (HTTP) using a service-based interface (SBI) N2 interface or radio resource control (RRC) message via a Central Unit for Control Plane (CU-CP), and
the data registration request includes metadata for data registration and security keys for authentication.

3. The apparatus of claim 1, wherein the processing circuitry further configures the DCF to check UE context and metadata through verification with an Access and Mobility Function (AMF), a Security Anchor Function (SEAF), or a Data Verification and Security Function (DVSF).

4. The apparatus of claim 1, wherein the processing circuitry further configures the DCF to select a Data Storage Function (DSF) in response to a determination that the UE is allowed to send data to the DSF.

5. The apparatus of claim 4, wherein the processing circuitry further configures the DCF to select the DSF based on at least one of data type, location, security requirements, or single Network Slice Selection Assistance Information (S-NSSAI).

6. The apparatus of claim 4, wherein the processing circuitry further configures the DCF to configure the DSF with the data ID, UE context, data labels, metadata, and policy of storing data from the UE.

7. The apparatus of claim 6, wherein the processing circuitry further configures the DCF to:
receive data from the UE in the data registration request; and
send the data from the data registration request to the DSF during configuration of the DSF.

8. The apparatus of claim 7, wherein the processing circuitry further configures the DCF to send a set of data from multiple data registration requests to the DSF.

9. The apparatus of claim 1, wherein the processing circuitry further configures the DCF to:
send a data collection information message to the UE; and
receive, in response to reception of the data collection information message by the UE, a data collection accept message from the UE that indicates whether the data collection information message is accepted by the UE.

10. The apparatus of claim 9, wherein:
the data collection information message includes data metadata, a data collection policy, the data ID, and a selected Data Storage Function (DSF) identifier, and
the data collection policy and parameters for data transfer are stored in the UE, and the data collection policy includes collection frequency.

11. The apparatus of claim 9, wherein the processing circuitry further configures the DCF to:
select a Data Storage Function (DSF) in response to a determination that the UE is allowed to send data to the DSF; and
configure the DSF with the data ID, UE context, data labels, metadata, and policy of storing data from the UE.

12. The apparatus of claim 1, wherein the processing circuitry further configures the DCF to:
receive, from a next generation NodeB (xNB), a data session establishment request from the UE to establish a data session, the data session establishment request including the data ID, data labels and Data Storage Function (DSF) identifiers, and security keys for data; and
in response to reception of the data session establishment request, send a data session establishment response to the UE via the xNB, the data session establishment response indicating whether the data session is established successfully.

13. The apparatus of claim 12, wherein the processing circuitry further configures the DCF to in response to reception of the data session establishment request:
retrieve a UE/DCF key from a Security Anchor Function (SEAF); and
use the UE/DCF key to verify the UE, the data ID, metadata, an assigned DSF, routing information, and additional keys for the data prior to sending the data session establishment response.

14. The apparatus of claim 1, wherein the processing circuitry further configures the DCF to:
receive, from a Service Orchestration and Chaining Function (SOCF), a data verification request, the data verification request based on a data session establishment request sent to the SOCF from the UE via a next generation NodeB (xNB) to establish a data session, the data session establishment request including the data ID, data labeling and Data Storage Function (DSF) identifiers, and security keys for data; and
in response to reception of the data verification request, verify data information for the SOCF to send a data session establishment response to the UE via the xNB, the data session establishment response indicating whether the data session is established successfully.

15. The apparatus of claim 1, wherein the processing circuitry further configures the DCF to:
receive, from a Service Orchestration and Chaining Function (SOCF), a data service request that includes a data filter, the data filter containing at least one of the data ID, data service, or metadata; and
in response to reception of the data service request, look up at least one of data in a data registry using the data filter or the data service in a service registry using a Service Registration Function (SRF).

16. The apparatus of claim 15, wherein the processing circuitry further configures the DCF to:
select a Data Storage Function (DSF) for the data service or data storage, and
send a data service response to the SOCF, the data service response including a DSF identifier of the DSF.

17. An apparatus configured to operate as a user equipment (UE), the apparatus comprising:
processing circuitry to configure UE to:
send a data registration request to a Data Control Function (DCF) in a 6^{th} generation system (6GS);
receive, in response to reception of the data registration request by the DCF, a data registration response from the DCF to indicate whether the data registration request is accepted;
receive a data collection information message from the DCF; and
send, in response to reception of the data collection information message, a data collection accept message to the DCF that indicates whether the data collection information message is accepted, at least one of the data registration response or the data collection information message including a data identifier (ID) allocated by the DCF to identify data for transfer between the UE and a Data Storage Function (DSF) in the 6GS; and
a memory configured to store the data ID.

18. The apparatus of claim 17, wherein the processing circuitry further configures the UE to:
transfer data with the DSF using at least one of a control plane or a user plane:
to transfer the data using the control plane, send the data directly to the DCF to forward to the DSF; and
to transfer the data using the user plane, establish at least one of:
a data session that is independent of a protocol data unit (PDU) session between the UE and the DSF, or
a PDU session managed by a Communication Control (Comm CF) or session management function (SMF).

19. A non-transitory computer-readable storage medium that stores instructions for execution by one or more processors of a Data Control Function (DCF) in a 6^{th} generation system (6GS), the one or more processors to configure the DCF to, when the instructions are executed:
receive a data registration request from a user equipment (UE);
allocate a data identifier (ID) in response to reception of the data registration request; and
send a data registration response to the UE to indicate whether the data registration request is accepted, the data registration response including the data ID.

20. The medium of claim 19, wherein the one or more processors further configure the DCF to:
select a Data Storage Function (DSF) in response to a determination that the UE is allowed to send data to the DSF;
configure the DSF with the data ID, UE context, data labels, metadata, and policy of storing data from the UE;
after configuration of the DSF, send a data collection information message to the UE; and
receive, in response to reception of the data collection information message by the UE, a data collection accept message from the UE that indicates whether the data collection information message is accepted by the UE.
